(19) United States
(12) Patent Application Publication
(10) Pub. No.: US 2015/0029635 A1
(43) Pub. Date: Jan. 29, 2015

(54) LOW COST ELECTRICAL STAMP

(71) Applicant: Generalplus Technology Inc., Hsinchu City (TW)

(72) Inventors: Bing Huang SHIH, Hsinchu City (TW); Tung-Tsai LIAO, Hsinchu City (TW); Yu Cheng LIAO, Jhubei City (TW); Li Sheng LO, Zhubei City (TW)

(73) Assignee: Generalplus Technology Inc., Hsinchu City (TW)

(21) Appl. No.: 14/266,897

(22) Filed: May 1, 2014

(30) Foreign Application Priority Data
Jul. 26, 2013 (TW) 102126885

(51) Int. Cl. H01F 7/06

(52) U.S. Cl. CPC H01F 7/064
USPC 361/152

(57) ABSTRACT

A low cost electrical stamp is provided in the present invention. The low cost electrical stamp includes a magnetic cylinder matrix, a print circuit board (PCB), a control circuit and an interface circuit. The magnetic cylinder matrix includes a plurality of magnetic cylinders. The PCB includes a plurality of electromagnets whose positions are corresponding to the positions of the magnetic cylinders. The control circuit is coupled to the electromagnets of the PCB to control the magnetic field direction of the electromagnets. The interface circuit is coupled to the control circuit to couple to a computing device. When the low cost electrical stamp is coupled to the computing device through the interface circuit, the computing device programs the control circuit by a diagram. The control circuit magnetizes the electromagnets to change the positions of the magnetic cylinders according to the diagram.

This application claims priority of No. 102126885 filed in Taiwan R.O.C. on Jul. 26, 2013 under 35 USC 119, the entire content of which is hereby incorporated by reference.

### BACKGROUND OF THE INVENTION

1. Field of the Invention

The invention relates to a stamp, and more particularly to a low cost electrical stamp.

2. Related Art

In traditional East Asian cultures, Stamp occupies a very important position. Not only is stamp in daily life usage, but stamp patterns, text and stamp carving style has high artistic value. At present, using the stamp to represent signature is still widespread in East Asia and India, and legally binding. Thus, the stamp must be safekeeping, to avoid being stolen. However, the stamp pattern is still produced by carving of human or machine. When the carving is completed, user cannot change the stamp pattern.

### SUMMARY OF THE INVENTION

In view of the above-identified problems, it is therefore an object of the invention to provide a low cost electrical stamp, such that user can change the stamp pattern by magnetizing the magnetic cylinders of the electrical stamp.

To achieve the above-identified object, the invention provides a low cost electrical stamp. The low cost electrical stamp includes a magnetic cylinder matrix, a print circuit board (PCB), a control circuit, and an interface circuit. The magnetic cylinder matrix includes a plurality of magnetic cylinders. The PCB includes a plurality of electromagnets. The positions of the electromagnets are corresponding to the positions of the magnetic cylinders. The control circuit is coupled to the electromagnets of the PCB for controlling the magnetic field direction of the electromagnets. The interface circuit is coupled to the control circuit for being coupled to a computing device. When the low cost electrical stamp is coupled to the computing device through the interface circuit, the computing device programs the control circuit according to a diagram. The control circuit magnetizes the electromagnets to change the positions of the magnetic cylinders according to the diagram, such that user can use a seal paste to stamp the diagram.

According to the low cost electrical stamp in a preferred embodiment of the present invention, the interface circuit is a universal serial bus circuit when a wired communication is taken as an example. When the wireless communication is taken as example, the interface circuit can be a Bluetooth module, an IR communication module, a WIFI module or a near field communication module. Also, in a preferred embodiment of the present invention, the computing device can be a personal computer, a laptop computer, a tablet computer or a smartphone.

The spirit of the present invention is to use the magnetic cylinder matrix to cooperate with the electromagnets in PCB, such that the control circuit can program the electromagnet array of PCB to shift the magnetic cylinders of the magnetic cylinder matrix. Therefore, the gray scale diagram can be represented. Also, user can put the magnetic cylinders to a seal paste to stamp the programmed diagram.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 illustrates a diagram depicting the low cost electrical stamp according to a preferred embodiment of the present invention.

FIG. 2A illustrates a diagram depicting a pattern to be programmed to the low cost electrical stamp according to a preferred embodiment of the present invention.

FIG. 2B illustrates a diagram depicting the polarity of the electromagnets according to a preferred embodiment of the present invention.

FIG. 2C illustrates a diagram depicting the pattern stamped by the low cost electrical stamp according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

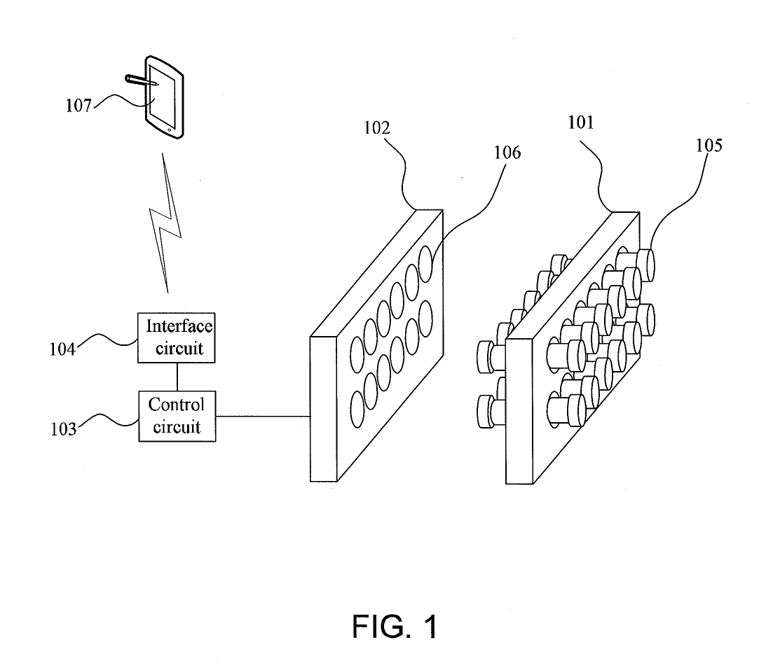

FIG. 1 illustrates a diagram depicting the low cost electrical stamp according to a preferred embodiment of the present invention. Referring to FIG. 1, the low cost electrical stamp includes a magnetic cylinder matrix 101, a print circuit board (PCB) 102, a control circuit 103, and an interface circuit 104. The magnetic cylinder matrix 101 includes a plurality of magnetic cylinders 105. The PCB 102 includes a plurality of electromagnets 106. The positions of the electromagnets 106 are corresponding to the positions of the magnetic cylinders 105. After the magnetic cylinders is magnetized, the polarity of each contact face of the magnetic cylinders is the same as the polarity of the corresponding electromagnets 106 of the PCB. The control circuit 103 is coupled to the electromagnets 106 of the PCB 102 for controlling to the magnetic field direction of the electromagnets 106. The coil part of the electromagnets 106 can be made of the layout of the copper foil in the multi-layer PCB, and the core part of the electromagnets 106 may adopt putting iron-silicategel into via of PCB or plating.

In order to easily describe the spirit of the present invention, in this embodiment, a mobile device 107 is provided. Further, the interface circuit 104 adopts a Bluetooth module or NFC module to serve as example.

When user starts using the electrical stamp, user may execute an application software in the mobile device 107 to establish a connection to the electrical stamp with Bluetooth module or near field communication (NFC) module. When the connection is established, user may choose a pattern from the mobile device and then transmits the pattern to the control circuit 103 through the interface circuit 104. According to the grayscale of the pattern transmitted from the mobile device 107, the control circuit 103 controls the polarity of the electromagnets 106 of the PCB 102. Next, when the PCB 102 combines the magnetic cylinder matrix 101, the magnetic cylinders represents high or low status according to the polarities of the electromagnets. Since the number of the magnetic cylinders 105 is sufficient to show the grayscale of the pattern, user can use the seal paste on the magnetic cylinder matrix 101, and then stamp the pattern on paper.

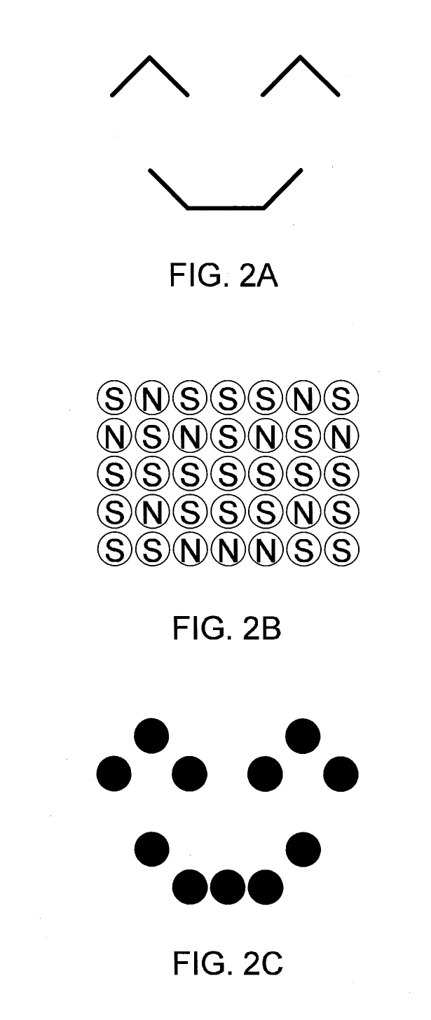

In order to conveniently describe the spirit of the present invention, the following embodiment adopts a simple pattern to serve as an example such that people having ordinary skill in the art can implement the present invention. Assuming the magnetic cylinder matrix 101 is a 5×7 matrix. First, user selects the smile pattern as shown in FIG. 2A. Next, the smile pattern is transmitted to the control circuit 103 through the interface circuit 104 to magnetize the electromagnets 106 of the PCB 102. After the magnetization, the polarity of the electromagnets 106 are respectively as shown in FIG. 2B. If the polarities of the magnetic cylinders 105, which face the PCB 102, are all N, a part of magnetic cylinders in the magnetic cylinders 105 would be attracted by the electromagnets 106, the other part of magnetic cylinders in the magnetic cylinders 105 would be repelled. After all, user may use the seal paste on the magnetic cylinder matrix 101 to stamp the stamp pattern as shown in FIG. 2C.

Although the abovementioned embodiment uses the simple pattern to describe the spirit the present invention, people having ordinary skill in the art should know that the more complex pattern could be stamped if the number of the magnetic cylinders 105 are sufficient. For example, a stamp pattern can be divided a plurality of areas to serve as pixels. The more the black dot in the area, the darker the area is. On the contrary, the less the black dot in the area, the lighter the area is. Thus, the grayscale can be represented to stamp a detailed pattern.

According to the abovementioned embodiment, only the portion near the PCB 102 in the magnetic cylinders 105 of the magnetic cylinder matrix 101 need to be magnetized. Thus, the magnetic cylinders 105 may be made of magnetizable material or only one part of magnetic cylinders 105 near the PCB 102 is made of magnetizable material.

In the abovementioned embodiment, the interface circuit 104 adopts the Bluetooth module or NFC module to serve as an example. After referring to the abovementioned embodiment, people having ordinary skill in the art should know that the interface circuit 104 would be universal serial bus (USB) when the mobile device 107 is replaced by PC or laptop computer. Thus, the present invention is not limited thereto. Furthermore, the mobile device 107 may be a smartphone or a tablet computer. The present invention is not limited thereto.

In summary, the spirit of the present invention is to use the magnetic cylinder matrix to cooperate with the electromagnets in PCB, such that the control circuit can program the electromagnet array of PCB to shift the magnetic cylinders of the magnetic cylinder matrix. Therefore, the gray scale diagram can be represented. Also, user can put the magnetic cylinders to a seal paste to stamp the programmed diagram. Furthermore, through the embodiment of the present invention, user can change the stamp pattern by a diagram in mobile device or PC.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A low cost electrical stamp, comprising:
a magnetic cylinder matrix, comprising a plurality of magnetic cylinders;
a print circuit board (PCB), comprising a plurality of electromagnets, wherein positions of the electromagnets are corresponding to the positions of the magnetic cylinders;
a control circuit, coupled to the electromagnets of the PCB, for controlling the magnetic field direction of the electromagnets; and
an interface circuit, coupled to the control circuit, for being coupled to a computing device,
wherein, when the low cost electrical stamp is coupled to the computing device through the interface circuit, the computing device programs the control circuit according to a diagram,
wherein the control circuit magnetizes the electromagnets to change the positions of the magnetic cylinders according to the diagram, such that user can use a seal paste to stamp the diagram.

2. The low cost electrical stamp according to claim 1, wherein the interface circuit is a universal serial bus circuit.

3. The low cost electrical stamp according to claim 1, wherein the computing device is selected from the group consisting of:
a personal computer;
a laptop computer;
a tablet computer; and
a smartphone.

4. The low cost electrical stamp according to claim 1, wherein the interface circuit is a wireless communication module, and the computing device has a corresponding wireless communication module.

5. The low cost electrical stamp according to claim 4, wherein the wireless communication module is selected from the group consisting of:
a Bluetooth module;
an IR communication module;
a WIFI module; and
a near field communication module.

6. The low cost electrical stamp according to claim 1, wherein each of the magnetic cylinders comprises:
a first portion, wherein the first portion faces the PCB; and
a second portion, connected to the first portion,
wherein the first portion is made of a magnetic material.

7. The low cost electrical stamp according to claim 1, wherein the polarity of a terminal of the magnetic cylinder of the magnetic cylinder matrix is one of S or N after the magnetic cylinder is magnetized.
